(19) United States
(12) Patent Application Publication
(10) Pub. No.: US 2013/0320148 A1
(43) Pub. Date: Dec. 5, 2013

(54) IMPELLER, CENTRIFUGAL PUMP INCLUDING THE SAME, AND AIRCRAFT FUEL SYSTEM INCLUDING THE CENTRIFUGAL PUMP

(71) Applicant: Steven Alan Lewis, South Bend, IN (US)

(72) Inventor: Steven Alan Lewis, South Bend, IN (US)

(73) Assignee: HONEYWELL INTERNATIONAL INC., Morristown, NJ (US)

(21) Appl. No.: 13/488,689

(22) Filed: Jun. 5, 2012

(51) Int. Cl. B64D 37/02; F04D 1/04

(52) U.S. Cl. 244/135 R; 415/203

(57) ABSTRACT

An impeller, a centrifugal pump, and an aircraft fuel system are provided. The impeller includes a central hub disposed along a rotational axis of the impeller and that defines an axial bore extending through at least a portion of the central hub along the rotational axis. The central hub further defines an opening to the axial bore at a leading end of the central hub. The impeller further includes an impeller section spaced from the leading end and that includes at least one impeller vane fixed to the central hub. The impeller further includes an inducer section that is disposed between the leading end of the central hub and the impeller section and that includes at least one inducer vane extending along an outer surface of the central hub. The central hub defines at least one radial aperture in the inducer section in fluid communication with the axial bore.

### TECHNICAL FIELD

The present invention generally relates to an impeller for a centrifugal pump, a centrifugal pump including the impeller, and an aircraft fuel system including the centrifugal pump. In particular, the present invention relates to an impeller that maximizes centrifugal pump efficiency, particularly in the presence of fluid input having a vaporized fluid and liquid fluid, a centrifugal pump including the impeller, and an aircraft fuel system including the centrifugal pump.

### BACKGROUND

Typical gas turbine engine fuel supply systems include a fuel source, such as a fuel tank, and one or more pumps that draw fuel from the fuel tank and deliver pressurized fuel to the fuel manifolds and fuel nozzles in the engine combustor via a main supply line. These pumps may include an aircraft or tank level pump, a boost pump, and a high pressure pump. The boost pump is typically a centrifugal pump and the high pressure pump is typically a gear pump, though in some applications the high pressure pump may also be a centrifugal pump.

Centrifugal pumps generally include a pump housing with a fluid inlet into the pump housing. An impeller is rotatably disposed in the pump housing for pressurizing the fluid, and the impeller is typically driven by an engine gear box. The impeller rotates at high speeds to draw the fluid in and to pressurize the fluid. The pressurized fluid is directed to a pump outlet. In the aircraft fuel systems, the pressurized fluid is fuel and the pressurized fuel is provided from the centrifugal pump to either the high pressure pump and/or to the main supply line.

There is a general desire to maximize pressure in the pressurized fuel, or to maximize the efficiency of the centrifugal pumps in pressurizing the fuel in aircraft fuel systems. Under certain operating conditions, such as at low atmospheric pressures associated with high altitudes at which gas turbine engines in aircraft operate, the centrifugal pumps may operate at low fuel inlet pressures. At the low fuel inlet pressures, a high amount of vaporized fuel may be present with liquid fuel at the fuel inlet and may result in inefficient pressurization of the fuel. As a result, insufficient pressures may be realized in the pressurized fuel based upon the high amount of vaporized fuel at the fuel inlet, or pressurization may be inefficient.

While efforts have been made to separate vaporized fuel from liquid fuel at the fuel inlet of centrifugal pumps in gas turbine engines, such efforts often result in loss of the vaporized fuel or routing of the vaporized fuel out of the centrifugal pump, thereby requiring auxiliary mechanisms for handling the vaporized fuel.

Accordingly, it is desirable to provide a centrifugal pump that maximizes efficiency in pressurizing fuel, or any liquid that is to be pressurized by the centrifugal pump, under conditions at which low pressures result in a high amount of vaporized fluid being present in the fluid inlet to the centrifugal pump. It is also desirable to provide a centrifugal pump that maximizes efficiency in pressurizing liquid without requiring routing of the vaporized fluid out of the centrifugal pump. Furthermore, other desirable features and characteristics of the present invention will become apparent from the subsequent detailed description of the invention and the appended claims, taken in conjunction with the accompanying drawings and this background of the invention.

### BRIEF SUMMARY

An impeller for a centrifugal pump, a centrifugal pump including the impeller, and an aircraft fuel system including the centrifugal pump are provided herein. In an embodiment, the impeller includes a central hub that is disposed along a rotational axis of the impeller and that defines an axial bore that extends through at least a portion of the central hub along the rotational axis. The central hub further defines an opening to the axial bore at a leading end of the central hub. The impeller further includes an impeller section that includes at least one impeller vane fixed to the central hub. The impeller section is spaced from the leading end of the central hub. The impeller further includes an inducer section that is disposed between the leading end of the central hub and the impeller section. The inducer section includes at least one inducer vane that extends along an outer surface of the central hub. The central hub defines at least one radial aperture in the inducer section. The at least one radial aperture is in fluid communication with the axial bore to facilitate fluid flow from adjacent the at least one inducer vane into the axial bore.

In another embodiment, a centrifugal pump includes a pump housing including a fluid inlet and a fluid outlet. An impeller is disposed in the housing and is rotatable about a rotational axis. The impeller includes a central hub that is disposed along a rotational axis of the impeller and that defines an axial bore that extends through at least a portion of the central hub along the rotational axis. The central hub further defines an opening to the axial bore at a leading end of the central hub. The impeller further includes an impeller section that includes at least one impeller vane fixed to the central hub. The impeller section is spaced from the leading end of the central hub. The impeller further includes an inducer section that is disposed between the leading end of the central hub and the impeller section. The inducer section includes at least one inducer vane that extends along an outer surface of the central hub. The central hub defines at least one radial aperture in the inducer section. The at least one radial aperture is in fluid communication with the axial bore to facilitate fluid flow from adjacent the at least one inducer vane into the axial bore.

In another embodiment, an aircraft fuel system includes a fuel tank, a centrifugal pump, and a main fuel line. The centrifugal pump is in fluid communication with the fuel tank for receiving fuel from the fuel tank. The main fuel line in fluid communication with the centrifugal pump for receiving pressurized fuel from the centrifugal pump. The centrifugal pump includes a pump housing including a fluid inlet and a fluid outlet. An impeller is disposed in the housing and is rotatable about a rotational axis. The impeller includes a central hub that is disposed along a rotational axis of the impeller and that defines an axial bore that extends through at least a portion of the central hub along the rotational axis. The central hub further defines an opening to the axial bore at a leading end of the central hub. The impeller further includes an impeller section that includes at least one impeller vane fixed to the central hub. The impeller section is spaced from the leading end of the central hub. The impeller further includes an inducer section that is disposed between the leading end of the central hub and the impeller section. The inducer section includes at least one inducer vane that extends along an outer surface of the central hub. The central hub defines at least one radial aperture in the inducer section. The at least one radial aperture is in fluid communication with the axial bore to facilitate fluid flow from adjacent the at least one inducer vane into the axial bore.

### BRIEF DESCRIPTION OF THE DRAWINGS

The present invention will hereinafter be described in conjunction with the following drawing figures, wherein like numerals denote like elements, and wherein:

FIG. 1 is a schematic view of an aircraft fuel system in accordance with an embodiment including a centrifugal pump, a gear pump, and a main fuel line;

FIG. 2 is a cross-sectional side view of a centrifugal pump in accordance with an embodiment, with the centrifugal pump including an impeller having a central hub that defines an axial bore and that further defines a plurality of radial apertures in fluid communication with the axial bore; and

FIG. 3 is a side view of the impeller of FIG. 2.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

An impeller, a centrifugal pump including the impeller, and an aircraft fuel system including the centrifugal pump are provided herein. The impeller maximizes centrifugal pump efficiency, particularly when a fluid input having a high vaporized fluid content, by separating at least some vaporized fluid that travels through the impeller in an inducer section of the impeller and by returning the vaporized fluid upstream through a central hub of the impeller. By separating at least some of the vaporized fluid and returning the vaporized fluid upstream, a higher proportion of liquid is ultimately present in the fluid that is pressurized by the impeller. Because higher liquid to vapor content in fluid to be pressurized corresponds to higher pump efficiency, pump efficiency is maximized by employing the impeller described herein. Further, once the vaporized fluid is delivered upstream, and without being bound to any particular theory, pressure impingement may enable a portion of the vaporized fluid to be compressed and condensed to thereby increase a ratio of liquid to vaporized fluid in the fluid input into the impeller.

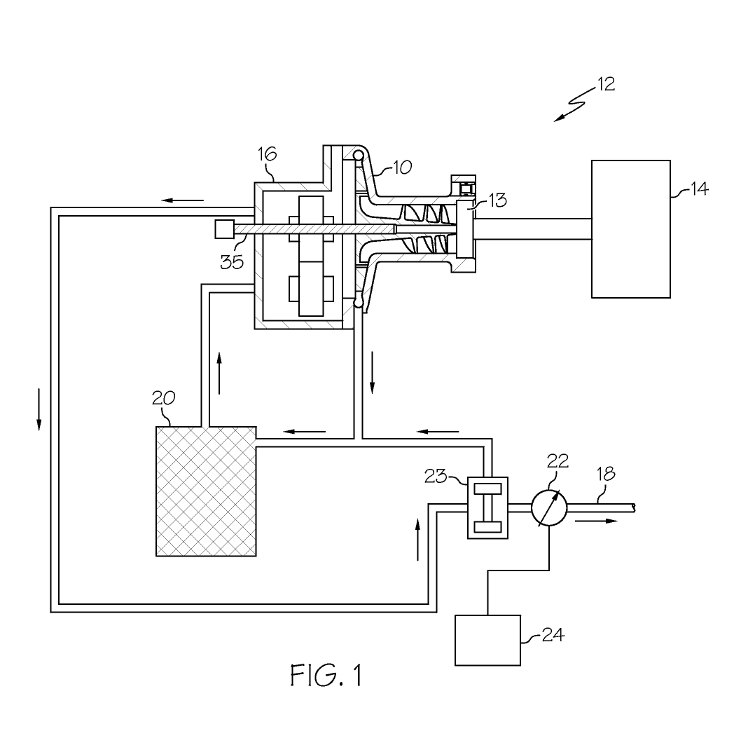

The impeller and centrifugal pump may be employed to pump any type of fluid, but are particularly suitable for pumping fluid that has a high vaporized fluid content. For example, as shown in FIG. 1, the centrifugal pump 10 may be included as part of an aircraft fuel system 12 and provides particular benefits due to low atmospheric pressures associated with high altitudes at which aircraft fuel systems operate during flight, which result in low fuel inlet pressures and a high amount of vaporized fuel at a fuel inlet 13. As shown in FIG. 1, the exemplary aircraft fuel system 12 includes the centrifugal pump 10 and a fuel tank 14, and may further include a gear pump 16. The centrifugal pump 10 is in fluid communication with the fuel tank 14 for receiving fuel from the fuel tank 14. The aircraft fuel system 12 further includes a main fuel line 18 in fluid communication with the centrifugal pump 10 for receiving pressurized fuel from the centrifugal pump. In an embodiment, as shown in FIG. 1, the gear pump 16 is present and is in fluid communication with the centrifugal pump 10 for receiving pressurized fuel from the centrifugal pump 10 and for further pressurizing the pressurized fuel, with a fuel filter 20 optionally disposed between the centrifugal pump 10 and the gear pump 16. In this embodiment, the centrifugal pump 10 functions as a boost pump for pressurizing the fuel to the gear pump 16 to minimize cavitation during operation of the gear pump 16, and the centrifugal pump 10 may also be employed to maintain constant pressure in the main fuel line 18. Thus, while the centrifugal pump 10 is in fluid communication with the main fuel line 18 in this embodiment, the gear pump 16 is disposed between the centrifugal pump 10 and the main fuel line 18 for further pressurizing the fuel prior to introduction into the main fuel line 18. In another embodiment, although not shown, the centrifugal pump 10 is the only pump that pressurizes the fuel, i.e., the gear pump 16 may be omitted from the aircraft fuel system 12. A metered flow valve 22 may be disposed after the centrifugal pump 10 and, when present, after the gear pump 16 in the main fuel line 18 for controlling fuel flow out of the aircraft fuel system 12, and the metered flow valve 22 may be controlled by a computer control module 24 of the aircraft. A bypass valve 23 may be disposed in the main fuel line 18 prior to the metered flow valve 22 and after the centrifugal pump 10 and, when present, the gear pump 16.

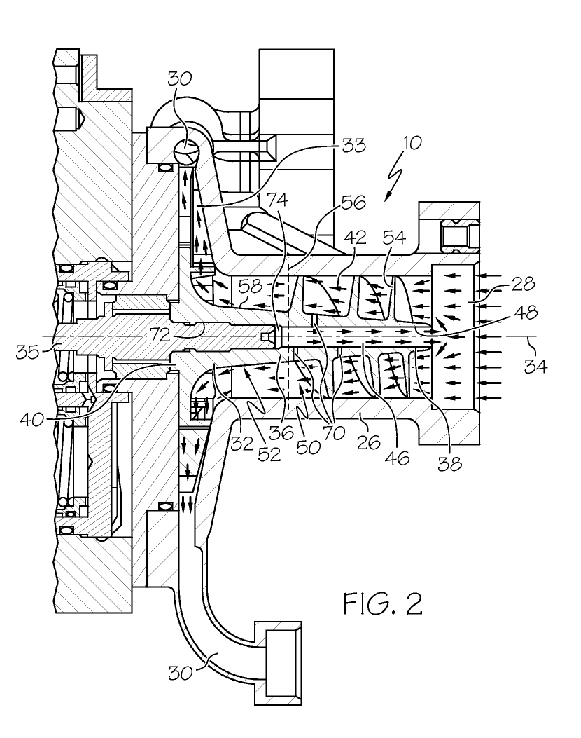

Referring now to FIG. 2, which shows an exemplary embodiment of a centrifugal pump 10 in greater detail, the centrifugal pump 10 includes a pump housing 26 that includes a fluid inlet 28 and a fluid outlet 30. As referred to herein, the fluid inlet 28 refers to the area within the pump housing 26 that defines a fluid flow path prior to the fluid contacting an inducer vane (to be described in further detail below). An impeller 32 is disposed in the pump housing 26 and is rotatable about a rotational axis 34. The centrifugal pump 10 also includes a driveshaft 35 that is fixed to the impeller 32 for rotating the impeller 32 about the rotational axis 34. The driveshaft 35 may be a common driveshaft 35 with another pump, such as the gear pump 16 as shown in FIG. 1.

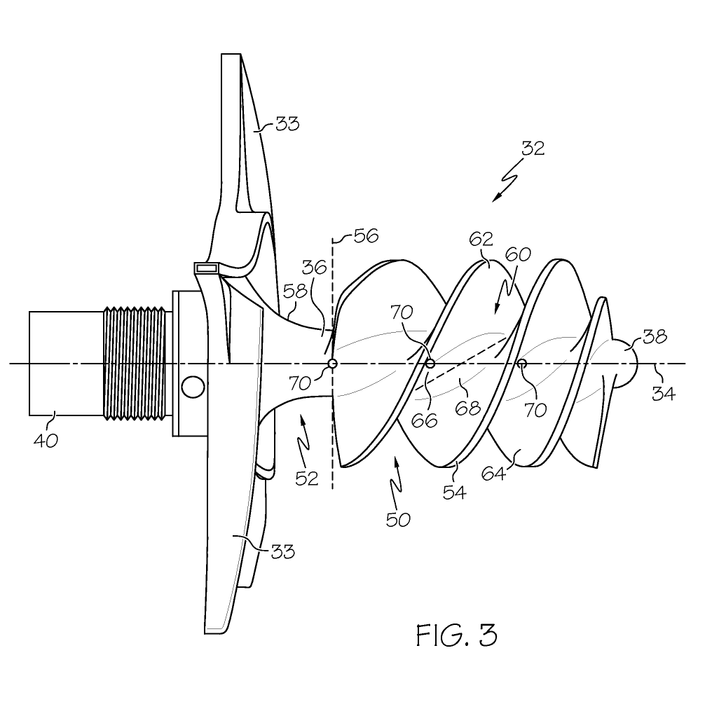

Referring to FIGS. 2 and 3, the impeller 32 includes a central hub 36 that is disposed along the rotational axis 34 of the impeller 32. The central hub 36 includes a leading end 38 that is proximal to the fluid inlet 28 of the centrifugal pump 10, and a trailing end 40 that is downstream of the leading end 38 in the direction of intended fluid flow 42 through the centrifugal pump 10. As shown in FIG. 2, the central hub 36 defines an axial bore 46 that extends through at least a portion of the central hub 36, along the rotational axis 34. The central hub 36 further defines an opening 48 to the axial bore 46 at the leading end 38 of the central hub 36. In an embodiment, the opening 48 to the axial bore 46 is defined along the rotational axis 34 such that the opening 48 and the axial bore 46 align with the intended direction of fluid flow 42 through the centrifugal pump 10.

The impeller 32 further includes an inducer section 50 and an impeller section 52. The inducer section 50 is disposed between the leading end 38 of the central hub 36 and the impeller section 52, and the impeller section 52 is spaced from the leading end 38 of the central hub 36. The inducer section 50 includes at least one inducer vane 54 for drawing fluid into the impeller 32 and effecting a slight pressure increase in the fluid in preparation for further pressurizing the fluid in the impeller section 52. For purposes herein, the inducer section 50 begins at the leading end 38 of the central hub 36 and terminates at a plane 56 that passes through the central hub 36 and a terminal edge of a rearmost inducer vane 54 relative to the leading end 38 of the central hub 36. Also for purposes herein, the impeller section 52 begins immediately following the inducer section 50.

The at least one inducer vane 54 of the inducer section 50 extends along an outer surface 58 of the central hub 36 in a configuration that is adapted to draw fluid into the centrifugal pump 10 upon rotation of the impeller 32 about the rotational axis 34. In an embodiment, as best shown in FIG. 3, the at least one inducer vane 54 is a helical vane that winds about a circumference of the central hub 36 from adjacent the leading end 38 toward the impeller section 52. The at least one inducer vane 54 may include at least two inducer vanes 54 with the inducer vanes 54 extending in parallel relationship to each other to define a fluid channel 60 between the at least two inducer vanes 54. Alternatively, although not shown, the fluid channel 60 may be defined by a single inducer vane 54, with adjacent portions of the single inducer vane 54 defining the fluid channel 60 as the single inducer vane 54 winds about the central hub 36. The inducer vanes 54 each have a forward inducer vane wall 62, which generally faces the leading end 38 of the central hub 36 and represents a relatively low-pressure side 66 of the inducer vane 54 during operation, and a trailing inducer vane wall 64, which generally faces the impeller section 52 and represents a high-pressure side 68 of the inducer vane 54 during operation. The fluid channel 60 is defined by the forward inducer vane wall 62 and the trailing inducer vane wall 64 and, during operation, the trailing inducer vane wall 64 generally contacts the fluid and directs the fluid flow 42 in a swirl path, with lighter components such as vaporized fluid migrating inward and heavier components such as liquid migrating outward in the swirl path.

As shown in FIGS. 2 and 3, the impeller section 52 includes at least one impeller vane 33 that is fixed to the central hub 36 and that is adapted to further pressurize the fluid entering the impeller section 52. In this embodiment, the impeller section 52 is adapted to direct fluid flow radially relative to the rotational axis 34. The fluid outlet 30 in the pump housing 26 is disposed adjacent to and radially outward from the at least one impeller vane 33 to collect the radial fluid flow from the impeller section 52 and to convey the fluid flow out of the centrifugal pump 10.

As shown in FIGS. 2 and 3, the central hub 36 of the impeller 32 defines at least one radial aperture 70 in the inducer section 50, with the at least one radial aperture 70 extending radially relative to the rotational axis 34. The at least one radial aperture 70 is in fluid communication with the axial bore 46 to facilitate fluid flow from adjacent the at least one inducer vane 54 into the axial bore 46. Without being bound to any particular theory, it is believed that during operation of the impeller 32, under conditions in which a fluid input into the impeller 32 has a vaporized fluid content, the lighter vaporized fluid migrates inward toward the central hub 36 and heavier liquid in the fluid input migrates outward from the central hub 36. Due to the presence of the at least one radial aperture 70 in the inducer section 50, and due to increasing pressures from the leading end 38 of the central hub 36 toward the impeller section 52, the vaporized fluid is siphoned into the axial bore 46 through the at least one radial aperture 70 to thereby increase a ratio of liquid to vaporized fluid that is passed to the impeller section 52, where the presence of vaporized fluid has a greater impact on pump efficiency than in the impeller section 52. Fluid flow through the axial bore 46 is restricted to the at least one radial aperture 70 and the opening 48 at the leading end 38 of the central hub 36. In this regard, the at least one radial aperture 70 and the axial bore 46 facilitate return of separated vaporized fluid from downstream locations within the centrifugal pump 10 to upstream locations. Once the vaporized fluid is introduced into the axial bore 46, it is believed that pressure impingement on the vaporized fluid in the axial bore 46 from the fluid input at the leading end 38 of the central hub 36 may enable a portion of the vaporized fluid to be condensed to thereby increase a liquid content of the fluid input into the impeller 32.

In an embodiment, the at least one radial aperture 70 comprises a plurality of radial apertures 70 that are spaced along the central hub 36, along the direction of the rotational axis 34. However, it is to be appreciated that a number of radial apertures 70 and a total surface area of radial apertures 70 are subject to design considerations based upon intended fluid type, operational speeds of the impeller 32, size of the impeller 32, and other factors that affect flow dynamics of fluid through the impeller 32. Considerations regarding location of the at least one radial aperture 70 may impact siphoning of the vaporized fluid through the at least one radial aperture 70. Because the impact of vaporized fluid on pump efficiency is greater in the impeller section 52 than in the inducer section 50, in an embodiment, the at least one radial aperture 70 is defined only in the inducer section 50 and the central hub 36 is free from radial apertures 70 outside of the inducer section 50 to maximize siphoning of the vaporized fluid in the inducer section 50. In a further embodiment, the at least one radial aperture 70 is defined adjacent to the low-pressure side 66 of the at least one inducer vane 54. For example, as set forth above, the low-pressure side 66 may be located adjacent the forward inducer vane wall 62. For purposes herein, the low-pressure side 66 refers to an area of the fluid channel 60 that is in closer proximity to the forward inducer vane wall 62 than the trailing inducer vane wall 64. In this embodiment, the at least one radial aperture 70 is defined between the at least two inducer vanes 54, in the fluid channel 60, and the at least one radial aperture 70 is defined in closer proximity to the forward inducer vane wall 62 in the fluid channel 60 than to the trailing inducer vane wall 64 of the other inducer vane 54 that defines the fluid channel 60. In this manner, the at least one radial aperture 70 is positioned where the vaporized fluid is likely to concentrate within the impeller section 52 while minimizing siphoning of liquid in the fluid that is flowing through the impeller 32. In yet a further embodiment, the at least one radial aperture 70 is defined in closer proximity to the impeller section 52 than to the leading end 38 of the central hub 36, which may maximize siphoning into the axial bore 46 through the at least one radial aperture 70 due to increasing pressures in the fluid as it travels through the inducer section 50. The increasing pressures create a larger pressure differential between the fluid input at the leading end 38 of the central hub 36 and the fluid passing adjacent to the at least one radial aperture 70, thereby promoting greater siphoning of the vaporized fluid through the at least one radial aperture 70.

Due to the presence of the at least one radial aperture 70 and the axial bore 46 in the central hub 36, fluid continuing to the impeller section 52 from the inducer section 50 has a higher ratio of liquid to vaporized fluid than may otherwise exist in the absence of those features, thereby enabling more efficient pressurization of the fluid in the impeller section 52 even under conditions in which the fluid has high vaporized fluid content at the fluid inlet 28.

Referring to FIG. 2, in an embodiment, the impeller 32 further defines a driveshaft bore 72 that extends from the trailing end 40 of the central hub 36 toward the leading end 38 for receiving the driveshaft 35. The driveshaft bore 72 is isolated from the axial bore 46 by a fastening wall 74, and the driveshaft 35 of the centrifugal pump 10 is fastened to the fastening wall 74.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An impeller for a centrifugal pump, the impeller comprising:
a central hub disposed along a rotational axis and defining an axial bore extending through at least a portion thereof along the rotational axis, the central hub further defining an opening to the axial bore at a leading end of the central hub;
an impeller section including at least one impeller vane fixed to the central hub, wherein the impeller section is spaced from the leading end of the central hub; and
an inducer section disposed between the leading end of the central hub and the impeller section, the inducer section including at least one inducer vane extending along an outer surface of the central hub;
wherein the central hub defines at least one radial aperture in the inducer section and in fluid communication with the axial bore to facilitate fluid flow from adjacent the at least one inducer vane into the axial bore.

2. The impeller of claim 1, wherein the at least one radial aperture is defined adjacent to a low-pressure side of the at least one inducer vane.

3. The impeller of claim 1, wherein the at least one inducer vane is further defined as a helical vane that winds about a circumference of the central hub from adjacent the leading end toward the impeller section.

4. The impeller of claim 1, wherein the at least one inducer vane comprises at least two inducer vanes with the at least two inducer vanes extending in parallel relationship to each other to define a fluid channel therebetween.

5. The impeller of claim 4, wherein the at least one radial aperture is defined between the at least two inducer vanes.

6. The impeller of claim 4, wherein the fluid channel is defined by a forward inducer vane wall and a trailing inducer vane wall relative to the leading end of the central hub.

7. The impeller of claim 6, wherein the at least one radial aperture is defined between the at least two inducer vanes in closer proximity to the trailing inducer vane wall in the fluid channel than to the forward inducer vane wall.

8. The impeller of claim 1, wherein the at least one radial aperture is defined in closer proximity to the impeller section than to the leading end.

9. The impeller of claim 1, wherein the central hub is free from radial apertures outside of the inducer section.

10. The impeller of claim 1, wherein the at least one radial aperture comprises a plurality of radial apertures spaced along the central hub.

11. The impeller of claim 1, wherein fluid flow through the axial bore is restricted to the at least one radial aperture and the opening at the leading end of the central hub.

12. The impeller of claim 1, wherein the opening to the axial bore is defined along the rotational axis.

13. The impeller of claim 1, wherein the impeller section is adapted to direct fluid flow radially relative to the rotational axis.

14. A centrifugal pump comprising:
a pump housing comprising a fluid inlet and a fluid outlet; and
an impeller disposed in the pump housing and rotatable about a rotational axis, the impeller comprising:
a central hub disposed along the rotational axis and defining an axial bore extending through at least a portion thereof along the rotational axis, the central hub further defining an opening to the axial bore at a leading end of the central hub;
an impeller section including at least one impeller vane fixed to the central hub, wherein the impeller section is spaced from the leading end of the central hub; and
an inducer section disposed between the leading end of the central hub and the impeller section, the inducer section including at least one inducer vane extending along an outer surface of the central hub;
wherein the central hub defines at least one radial aperture in the inducer section and in fluid communication with the axial bore to facilitate fluid flow from adjacent the at least one inducer vane into the axial bore.

15. The centrifugal pump of claim 14, wherein the fluid outlet is disposed adjacent to and radially outward from the at least one impeller vane.

16. The centrifugal pump of claim 14, further comprising a driveshaft fixed to the impeller for rotating the impeller about the rotational axis.

17. The centrifugal pump of claim 16, wherein the impeller further defines a driveshaft bore extending from a trailing end of the central hub for receiving the driveshaft.

18. The centrifugal pump of claim 17, wherein the driveshaft bore is isolated from the axial bore by a fastening wall, and wherein the driveshaft is fastened to the fastening wall.

19. An aircraft fuel system comprising:
a fuel tank;
a centrifugal pump in fluid communication with the fuel tank for receiving fuel from the fuel tank, the centrifugal pump comprising:
a pump housing comprising a fluid inlet and a fluid outlet; and
an impeller disposed in the pump housing and rotatable about a rotational axis, the impeller comprising:
a central hub disposed along the rotational axis and defining an axial bore extending through at least a portion thereof along the rotational axis, the central hub further defining an opening to the axial bore at a leading end of the central hub;
an impeller section including at least one impeller vane fixed to the central hub, wherein the impeller section is spaced from the leading end of the central hub;
an inducer section disposed between the leading end of the central hub and the impeller section, the inducer section including at least one inducer vane extending along an outer surface of the central hub;
wherein the central hub defines at least one radial aperture in the inducer section and in fluid communication with the axial bore to facilitate fluid flow from adjacent the at least one inducer vane into the axial bore; and
a main fuel line in fluid communication with the centrifugal pump for receiving pressurized fuel from the centrifugal pump.

20. The aircraft fuel system of claim 19, further comprising a gear pump in fluid communication with the centrifugal pump for receiving the pressurized fuel from the centrifugal pump and for further pressurizing the pressurized fuel.
